(19) United States
(12) Patent Application Publication
(10) Pub. No.: US 2018/0007458 A1
(43) Pub. Date: Jan. 4, 2018

(54) Caseic

(71) Applicant: Zachary Nathaniel DeJarnette, Bradenton, FL (US)

(72) Inventor: Zachary Nathaniel DeJarnette, Bradenton, FL (US)

(21) Appl. No.: 15/593,011

(22) Filed: May 11, 2017

Related U.S. Application Data
(60) Provisional application No. 62/335,659, filed on May 12, 2016.

(51) Int. Cl. H04R 1/02; G10G 5/00; H04R 3/04; H04R 1/40; G10H 1/32; G10H 1/44

(52) U.S. Cl. CPC H04R 1/028; H04R 1/025; G10H 1/32; G10H 1/44; H04R 3/04; H04R 1/403; G10G 5/00; G10H 2210/155; H04R 2201/028; H04R 2420/07

(57) ABSTRACT

Caseic a guitar case that has a built in amplifier unit consisting of one or more speakers. The guitar case has a rectangular shape, versus the regular shape of a guitar. This case will include: Bluetooth capability, a guitar input, microphone input, multiple instrument inputs, a built in tuner, an external sound source input, and a DC supply unit also containing a rechargeable battery. An app available on any smart device will be made that will have a layout of guitar pedals that can be used to change the effect of the guitar plugged into the case, also including a drum machine. The speaker layout will consist of speakers on the top portion of case. There will be a microphone insert, mic effects, and a guitar insert along with all the knobs that are necessary to operate a guitar.

### INTRODUCTION

Caseic is a unique, efficiently portable, rectangular guitar case that contains one or more speakers to allow portability without the burden of carrying a PA system, multiple chords, amps, or guitar pedals, all integrated into one system, when performing outside of the home, specifically in a populated area.

### BACKGROUND OF THE INVENTION

This guitar case-amp related invention is mainly for street musicians, or other musicians who need a guitar case that contains all the elements that they use when playing music in front of an audience with limited power supply and space. Generally, when performing musicians need effect pedals, an amplifier for their vocals, multiple cords to connect their instruments into external sound sources, also a power supply unit that has to ability to power multiple amps and speakers. This causes several problems including having to carry around lots of heavy equipment. Also, an increase in equipment for musicians takes up more room and space that can be used for other means. Due to lack of power supply or space, when performing on the street, musicians cannot possibly play guitar or other instruments, and sing, without an external sound source, unless they go unplugged. An electric guitar cannot be heard loud enough without an amplifier, which causes the need for a power supply and other equipment to be used, causing difficulties transporting equipment and setting up.

In order to solve these problems, a guitar case is proposed with built in speakers, bluetooth capability, external sound source input, multiple instrument inputs, mic input, aux input, a built in tuner, also including an app (for any device) that contains all guitar effect pedals and a drum machine. Incorporated into the guitar case-amp system is all the knobs that are necessary to operate a guitar; these knobs include tone, volume, gain, etc. Knobs for mic effects are also necessary.

### SUMMARY OF THE INVENTION

The purpose of this invention is to allow more portability for musicians playing on the street, or in front of any audience requiring an instrument and mic, along with all the components necessary to provide entertainment without taking up extra room, or space. This is done by having an instrument case, that houses a guitar, connected by hinges, with integrated speakers wired throughout the body of the case. Straps may have to be used on the sides of the case in order to keep the case from becoming too heavy on the top or bottom, also keeping the weight balanced. This invention offers many advantages including the luxury of not having to transport all equipment that a musician may use during a performance.

Especially for street performing. It easily allows two (2) or more people to play or perform altogether using only one system due to having the capability of providing sound for multiple instruments include vocals, bass guitar, guitar, piano, ukulele, any instrument that can be used with a quarter inch or XLR cable. This invention can easily be used for a solo performance because of the AUX input or Bluetooth capability which will allow the musician to play a backing track, or any, but not limited to, recording behind their performance. Due to having a rechargeable battery or DC supply unit, also gives this invention the advantage of being even more portable, and beneficial to musicians. An app available on any smart device (smart phone, tablet, ipod, etc.) contains all the guitar effect pedals necessary when performing. Also including a drum machine in the app. As listed in this summary of the invention, these advantages should allow the problems to be solved as listed in the background of the invention.

### DESCRIPTION OF FIGURES

FIG. 1—Shows the invention from a 2-degree point of view facing up.

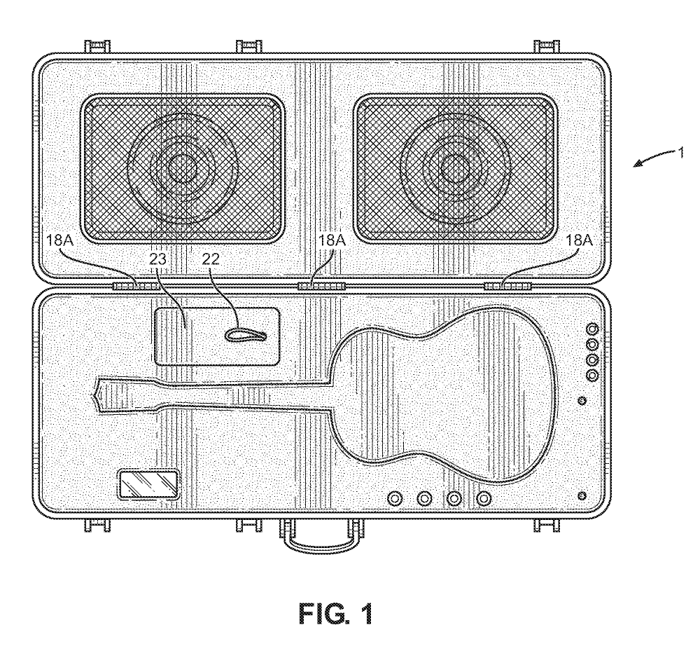

FIG. 2—Shows the invention fully expanded, as it would during operation.

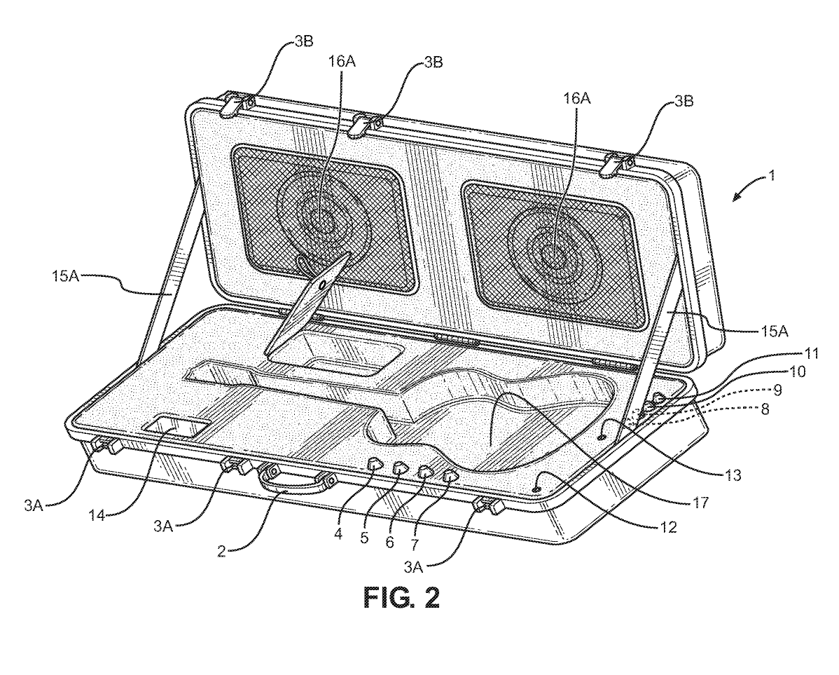

FIG. 3—Shows the back of the invention and what the case will look like closed.

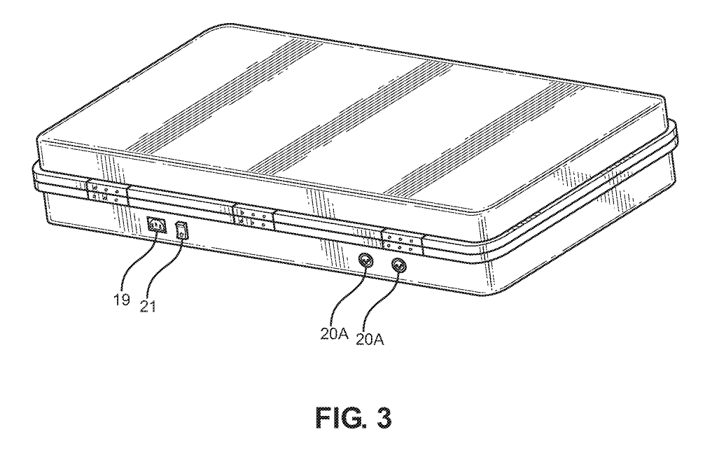

### DETAILED DESCRIPTION OF INVENTION

The invention is a guitar case 1 with built in speakers 16A (2) that connect to an internal power supply and an amplifier unit. The guitar will be stored in a compartment 17 in the case that will be universal and able to fit any size electric guitar. The guitar case will have a small compartment 23 for storing extra strings or cords. Attached to the compartment is a handle 22 for opening and closing. The guitar case opens and closes using hinges 18A (3) and latches closed using clamps 3B (3) connecting from the top side of the case to the bottom clamps 3A. To keep the weight balanced, one strap 15A (2) on each side will be used attached from the top portion of the case to the bottom. While the case is closed, a handle 2 will be used to carry and transport the case-amp. The guitar case will have a screen 14 displaying Bluetooth connection, battery power, effect pedal (through smart device app), and built in guitar tuner. The guitar case will have one quarter inch input 12 for a guitar, or other instrument that can be connected through a quarter inch, and the knobs necessary such as volume, treble, mid, and bass (4-7). Also added is a XLR input 13 for a microphone and the knobs necessary to change microphone effects (8-11). Located on the back bottom portion of the case is the A/C power supply unit 19 that can be powered through a wire connected to a wall outlet. To the right of that is a power switch 21 capable of turning the case-amp on and off. Also located on the back bottom portion of the case is two XLR inputs 20A capable connecting the case to an external sound system. An app available on any smart device will be able to connect to this case amp wirelessly consisting of guitar pedals that can change the effect of the guitar, and a drum machine on the app than can provide a backing track for the musician. This case will be Bluetooth compatible that can also provide a backing track for the musician. A built in tuner will be available with the case. Further improvements for this invention consist of a distortion/clean setting built into the case. Also this case will be battery powered and A/C powered. Further improvements consist of being powered by a rechargeable battery. Other future improvements consist of having extra XLR and quarter inch inputs to allow more instruments to be powered through this invention, which may require extra knobs to be installed. Future improvements for this case also consist of being able to hold different instruments, and have more storage space. Further improvements could also consist of speakers all around the bottom of the case, providing 360 degree sound.

### Numerical Reference

1—A guitar case with a built in amplifier consisting of two speakers and able to store any size shape electric guitar.
2—A handle made to carry or transport the case.
3A—Bottom part of clamps to keep the case from opening when closed.
3B—Top part of clamps.
4-7—Knobs necessary to operate a guitar amp.
8-11—Knobs necessary to change microphone effect.
12—Guitar quarter inch.
13—XLR input for microphone.
14—Screen showing Bluetooth On/Off, battery power, guitar tuner, and effect being used.
15A—Straps to keep the guitar weight balanced.
16A—Two identical speakers.
17—XLR input for a microphone.
18A—Hinges to open and close case.
19—A/C unit input.
20A—XLR inputs for external speakers.
21—Power on/off switch.
22—Handle for storage compartment.
23—Door for storage compartment.

1. A portable case comprising:
a storage area for a guitar having a top portion and a bottom portion;
a power supply capable of powering one or more speakers;
an amplifier unit for multiple different instruments;
at least one knob to operate a guitar amp;
at least one input connected to an external speaker;
an input to connect a cord from an A/C power supply unit into a wall outlet;
a power on/off switch;
a compartment;
wherein the power supply is configured to alternatively be powered by the A/C unit or a rechargeable battery;
further wherein, inputs for multiple instruments are positioned on the case;
further wherein, the top and bottom portion of the case are connected by hinges and straps.

2. The portable case of claim 1, wherein integrated into the case is Bluetooth operable to be connected wirelessly through an app on a smartphone device that includes at least one of an effect pedal and a drum machine.

3. The portable case of claim 1, further comprising a tuner powered by the power supply and a screen on the case configure to show at least one of a bluetooth on/off, a guitar tuner, an effect pedal, and battery power.

3-6. (canceled)

7. An instrument case, comprising:
a top portion and a bottom portion
at least one internal power supply;
at least one amplifier unit electrically coupled to the power supply;
at least one built in speaker powered by the internal power supply and amplifier unit;
an instrument compartment sized to receive a musical instrument;
an accessories compartment;
at least one hinge pivotally coupling the top portion to the bottom portion;
at least one clamp selectively coupling the top portion to the bottom portion;
a case handle coupled to one of the top or bottom portion;
at least one strap coupling the top portion to the bottom portion;
at least one screen display coupled to the case;
at least one input to allow wired connectivity to an instrument or microphone;
at least one knob configured to selectively alter a sound produced through the speaker;
an external power supply configured to connect to an outside power source; and
at least one output configured to connect the instrument case to an external sound system.

8. The instrument case of claim 7, further wherein the at least one screen display shows at least one of a bluetooth connection status, a power supply level, an audio effect setting, or an instrument tuning status.

9. The instrument case of claim 7, further wherein the at least one knob is at least one of a volume control knob, a treble control knob, a mid control knob, a bass control knob, or a microphone effect knob.

10. The instrument case of claim 7, further comprising a wireless transmitter and receiver configured to send and receive information from a user.

11. The instrument case of claim 10, wherein the information from a user is at least one of instrument effects, a type of drum machine, or a backing track.

12. The instrument case of claim 10, wherein the wireless transmitter and receiver is a bluetooth transmitter and receiver.

13. The instrument case of claim 7, wherein the internal power supply has batteries and is rechargeable through the external power supply.

14. The instrument case of claim 13, wherein the instrument case is powered by internal power supply when the batteries have sufficient charge.

15. The instrument case of claim 7, further wherein the at least one built in speaker comprises a first speaker in the top portion and a second speaker in the bottom portion.

16. The instrument case of claim 7, further comprising speakers all around the case, providing 360 degree sound.
